(19) United States
(12) Patent Application Publication
(10) Pub. No.: US 2023/0391620 A1
(43) Pub. Date: Dec. 7, 2023

(54) Compositions, Processes and Systems to Produce Hypochlorous Acid

(71) Applicant: River Refresh LLC, Fort Worth, TX (US)

(72) Inventors: Simon Joshua Jacobs, Lucas, TX (US); Marc John Patterson, Euless, TX (US)

(73) Assignee: River Refresh LLC, Fort Worth, TX (US)

(21) Appl. No.: 18/328,399

(22) Filed: Jun. 2, 2023

Related U.S. Application Data
(60) Provisional application No. 63/365,846, filed on Jun. 3, 2022.

(51) Int. Cl. C01B 11/04; B01J 39/18; B01J 39/07; B01J 47/018

(52) U.S. Cl. CPC C01B 11/04; B01J 39/18; B01J 39/07; B01J 47/018

(57) ABSTRACT

Hypochlorite salts and substantially dehydrated acid-form cation exchange resin beads are combined at specified ratios within a porous enclosure such as a pouch or sachet. Hypochlorous acid solutions are produced on demand by introducing the mixture-containing pouch into a chemical excess of water. Spontaneous exchange reactions occur at room temperature within a few minutes to produce aqueous hypochlorous acid, while the cations from the hypochlorite salt are simultaneously sequestered by the resin beads. The resin beads remain contained within the original porous enclosure to allow mechanical isolation or separation from the resulting solution.

### REFERENCE TO RELATED APPLICATIONS

This application claims priority to U.S. Provisional Patent Appl. No. 63/365,846.

### FIELD OF THE INVENTION

The formulation of hypochlorous acid by mixing water with shelf-stable alkali metal or alkaline earth hypochlorite salts, including basic alkaline earth hypochlorite salts, with acid form cation exchange resins, and the manufacture of materials and systems for the starting materials.

### BACKGROUND OF THE INVENTION

Hypochlorous acid has been known as a chemical species for over a century and its myriad health and safety benefits are well documented. Hypochlorous acid is the conjugate acid of hypochlorite ion.

Topical formulations of hypochlorous acid are available as over-the-counter and prescription medicines. Both are used in human and animal medicine as topical disinfectants and treatment aids in both acute and chronic settings for diverse maladies. Hypochlorous acid has also started to find favor as a sanitizer, disinfectant, and sterilant in many healthcare settings.

While hypochlorous acid has many applications, there are drawbacks as well with how it is normally produced, distributed, and stored. Hypochlorous acid undergoes autologous decomposition to hydrochloric acid and oxygen. As the pH drops by production of HCl, this decomposition process is autocatalytic. Much recent activity has been devoted to finding buffers to stabilize HOCl solutions against this autocatalytic reactivity, and others have proposed common buffering systems such as carbonate, bicarbonate, and neutral phosphate. Hypochlorous acid has a pKa of 7.46, therefore a buffer in the range of pH 5.0 to 6.5, or more preferably 5.5-6.0, ensuring >90% or more of the available hypochlorite species are present as hypochlorous acid, is preferred. However, even at the low concentrations useful in many applications (100-1000 ppm HOCl in water), the shelf life of hypochlorous acid solutions is limited to a period of a few months up to perhaps a year if atmospheric gasses are also excluded.

Chlorine chemistry forms the basis of large-scale sanitation for swimming pools, water parks, municipal drinking water sanitation around the world. Two compounds manufactured and distributed for these purposes on the megaton scale annually include sodium hypochlorite and calcium hypochlorite. Sodium hypochlorite is produced in the chlor-alkali process, while calcium hypochlorite is produced by multi-step reactions between chlorine gas and slurried calcium hydroxide (lime). Each commercial product contains sodium chloride as a consequence of the manufacturing process, and each is stabilized by the presence of a small amount of hydroxide ion: sodium hydroxide in the case of sodium hypochlorite and calcium hydroxide (lime) in the case of calcium hypochlorite. Sodium hypochlorite solution, commonly known as bleach, is available commercially in concentrations ranging up to 20% by weight, and the basic sodium hydroxide present results in a pH>12. Calcium hypochlorite is available commercially as ‘high-test hypochlorite’, or HTH, in granular form (also known as “granular calcium hypochlorite”) that contains approximately 70% calcium hypochlorite by weight, the balance comprising mostly of one or more of alkali chlorides, alkali hydroxides, alkaline earth chlorides, alkaline earth hydroxides, such as sodium chloride, calcium chloride, and calcium hydroxide. This calcium hypochlorite mostly dissolves in water at approximately 20% by weight concentration, leaving a small amount of calcium hydroxide (lime) in suspension. The pH of these solution/suspension mixtures is also around 12.

The oxidation-reduction potential (ORP) of hypochlorous acid/hypochlorite solutions is strongly dependent on pH according to the Nernst equation, yet at lower pH (less than 10), these solutions are not stable over long term, evolving various chlorine-containing byproducts.

To illustrate, the ORP of bleach and calcium hypochlorite solutions (pH˜12) is approximately 500 mV, whereas the ORP of properly formulated hypochlorous acid solutions (pH <=6) is around 1000 mV. As might be predicted by these ORP values, hypochlorous acid has been found to be about 80 times more effective a disinfectant as hypochlorite ion.

The instability of HOCl solutions and autodecomposition to HCl and O₂ is controlled by concentration, temperature, and pH. These factors can lead to limited and variable shelf life, even under the best conditions. The normal lifespan even for high pH solutions, e.g., household bleach, is approximately six months. Buffers can help, but additional ionic concentrations of, e.g., sodium chloride, seem to accelerate decomposition. The lifespan indicated by many data sheets ranges from 24 to 168 hours for dilute HOCl solutions generated by electrolysis of dilute mixtures of sodium chloride and acetic acid.

Additional problems with the current approaches include the terrible economics associated with shipping HOCl as a dilute solution or even concentrated NaCl electrolyte. The vast majority of the content is simply water, a resource which is universally available in the developed world without using carbon-based fuels for transport. We have identified a novel approach to remove the water from distribution and create the desired HOCl concentrations, normally 200-2000 ppm, but up to as much as 25,000 ppm, at the point of use. Inasmuch, we expect to realize economic benefits associated with reduced transportation costs, reduced spoilage, reproducible concentrations, and other benefits as will become apparent.

Ion-exchange reactions were originally conducted with natural zeolite materials, but these have given way to synthetic polymer resins. For the instant invention, we focus on cation exchange resins. These are typically crosslinked polymers, in the form of small beads or gels, which have a polymer-bound negative charge in the form of either a sulfonic acid anion R—SO₃⁻ or carboxylic acid anion R—COO⁻. As normally applied, for instance, in water softening, the resin is loaded with sodium ions, R—SO₃⁻Na⁺ or R—COO⁻Na⁺. Over time, as municipal water traverses the resins, hard water ions calcium (Ca²⁺) and magnesium (Mg²⁺) are exchanged for sodium ions, and the hardness, normally quantified as dissolved CaCO₃, is reduced.

A less common but still commercially available and well-known form of ion-exchange resin is the protonated or H⁺-form, R—SO3⁻H⁺ or R—COO⁻H⁺. These may be generated from the sodium forms by treatment with acid solutions of low pH (pH<3, and usually pH˜0). In effect these protonated resins are ‘solid acids’ which can exchange their proton for a different cation under the appropriate conditions of ionic concentration and pH.

### BRIEF STATEMENT OF THE INVENTION

A composition of matter can be stored in solid form and combined with water at the point of use to form dilute solutions of hypochlorous acid. In an embodiment, the resultant solutions largely if not almost entirely comprise hypochlorous acid, absent significant amounts of additional dissolved solids. Other embodiments include a family of processes which can lead to production of such a solution. And an embodiment of the invention includes a modular system which can be assembled at the point of use to carry out the processes and produce the solution at the point of use.

In an embodiment, one may employ combinations of shelf-stable alkali metal or alkaline earth hypochlorite salts, including basic alkaline earth hypochlorite salts, with acid form cation exchange resins. Acid form ion exchange resins are typically made of crosslinked benzenesulfonic acid or (meth)acrylic acid polymers that are insoluble in water. As these acid resins are typically supplied as a mixture containing approximately 50% resin and 50% water, it is especially preferred in the context of the instant invention to first dry the ion exchange resin at approximately 100-108 ° C. for a period of time sufficient to reduce the total mass by approximately 50%. In effect, the desired result of the drying process is the eliminate nearly all of the water, e.g. water that is volatile at approximately 212-225° F. or about 98% or 100% percent. Conventional oven drying for up to 12 hours is sufficient, although convection or forced air drying can accelerate this process. Heating above the noted temperature range can be deleterious to the resin structure and/or performance.

Each component of this composition may be stored independently of the other and is known to be shelf-stable for a period of months to years. Alternatively, the inventors have found that in dry form these two components, high-test hypochlorite and acid-form ion exchange resin, may conveniently be combined into sachets or packets containing dosing levels convenient for forming a desired concentration of hypochlorous acid in a defined volume of water.

While all acid-form ion exchange resins are operable in the instant invention, macroporous weak acid form resins, typically made from crosslinked acrylic acid or methacrylic acid derivatives, are most useful due to their specific effects with respect to pH and the rapid ion-exchange kinetics of the said type of resin which allows the processes of the instant invention to be substantially complete within a few minutes at room temperature.

In order to produce hypochlorous acid, the hypochlorite salt is dissolved in water and the resulting solution is mixed with the weak acid resin. In the correct ratio, the weak acid resin reacts with the hypochlorite salt and exchanges its protons for the alkali or alkaline earth cations of the hypochlorite salt, thus producing hypochlorous acid and resin-bound cations. The cation is attached by strong electrostatic attraction to the negative charges on the resin's carboxylate groups. In this manner, the purity of the HOCl solution produced relies only on the purity of the starting hypochlorite.

Commercial ‘high test hypochlorite’, a dry, shelf-stable formulation of calcium hypochlorite, containing small amounts of sodium and calcium chlorides and calcium hydroxide, and having 65% or 70% or more free available chlorine by mass, is especially suited to this invention. One advantage of small amounts of dry calcium chloride and sodium chloride present in such formulations is to absorb atmospheric moisture that may come in contact with the solid, prolonging its useful life. Other desiccant/hypochlorite combinations may be equally or more effective in prolonging the shelf life of various compositions. Even more preferred would be a purer form of calcium hypochlorite, such as >90% calcium hypochlorite, or dry lithium hypochlorite with a purity level of >90%, or magnesium hypochlorite mixed salts, such as magnesium hypochlorite hydroxide, also known as basic magnesium hypochlorite. These latter hypochlorite salts, however, are not presently commercially available at the same scale as the aforementioned calcium hypochlorite formulations; the 70% formulations are typically used for swimming pool sanitation and produced commercially in large quantities every year.

The granular form of ‘high test hypochlorite’ is somewhat slow to dissolve in the process of the instant invention, and in fact contains a trace of insoluble calcium hydroxide, an oxygen-containing mineral, largely insoluble in water. The calcium hydroxide present serves to consume some of the acid from the resin during the dissolution and mixing, and therefore an embodiment of the invention benefits from more than the minimum theoretical amount of resin required. A suitable solution might be produced from a mass ratio of dry resin to HTH of 5:1, about a 4-fold increase over the about 1.25:1 ratio which provides approximately ½ equivalent of ion-exchange resin H+ sites. Therefore, in the 5:1 mass ratio, there are approximately two molar equivalents of available protons for each molar equivalent of hypochlorite ions. A higher ratio of 7:1, 8:1, 9:1, 10:1, 11:1, or more results in more rapid attainment of the target pH while allowing as well for some degree of hardness (CO₂ dissolved as magnesium carbonate or calcium carbonate) in the source water. The process is most effective when carried out with distilled water, but additional resin may be added as indicated above to reduce or eliminate calcium & magnesium hardness associated with the source water.

Ideally the final pH of a hypochlorous acid solution produced by this invention is in a range from 4-7, and even more preferably in a range from 5-6. The mass ratio of resin to high test hypochlorite is dictated by the final target pH and possibly the hardness value of the starting water source.

The metal cations originally associated with hydroxide and carbonate are thus also bound by the insoluble resin and are then easily removed from the mixture by decantation, filtration, or similar physical process. Removing said cationic form of the resin separates the mixture into a solid portion and a liquid portion, where the solid portion contains all or a very high fraction of the cations originally contained by the active and bystander constituents of the hypochlorite salt component. Thus is formed a substantially insoluble cation exchange resin, that resin being in mixed cation form. The mixed cation form means that cations of two different types are present. A first type are protons, H+, which were provided originally in the resin in excess of those needed to be put into solution. A second type are metal ions [generically M] as Mⁿ⁺, which were formerly in solution and bound to the hypochlorite. Those metal ions M are those in which n=1 or 2, that is, metals falling into Group I or Group II on the periodic table, examples of which include Ca²⁺, Mg²⁺, Na⁺, K⁺. The rate of dissolution and reaction of the soluble fraction may be improved by grinding the commercial HTH material (typical granule size of 4-20 mesh) to a finer particle size, e.g. by using a mortar and pestle, by automated mechanical grinding methods, or other particle size reduction methods. If any of these methods are used, it is preferred to remove very fine particles (dust) of the hypochlorite which might lead to appearance or safety concerns.

Weak acid ion exchange resins that may be used are called the so-called hydrogen, protonated, or H⁺-form of these resins. Specifically useful and without limitation, we have found resins including Amberlite CG50 Type 1, Amberlite IRC83H, Amberlite MAC-3H, and ResinTech WACMP will all provide for success in the compositions of matter, processes, and systems of the instant invention. Granule size is typically 16-50 mesh. Often these resins in bulk form are supplied in water-wetted form, and, while dry resin is favored it is not required.

Once dried as previously described, the resin may be admixed with the above stabilized hypochlorite in one example of the present invention, the mixture being stable for some months. In other embodiment of compositions of matter and systems, provision may be made to store the materials separately, such that any remaining water in the resin does not activate, dissolve, or aid decomposition of the dry hypochlorite salt. Said separate storage may be accomplished, for instance, with a barrier including a seal, the barrier made of water-resistant or water absorbing polymer vapor barrier, such that the rate of water vapor exchange across the barrier remains small and also the use of desiccant contained within the packaging. Said compositions of matter may be packaged, for instance, within the same larger container, blister pack, or other grouping, together with the system of said invention and instructions for conducting the reaction outlined above in which H⁺-form resin and hypochlorous acid salt combine in an aqueous solution to form hypochlorous acid and a metal-ion form resin, for example and without limitation: Ca²⁺-resin, Mg²⁺-resin, or Li⁺-resin.

### BRIEF DESCRIPTION OF THE FIGURES

FIG. 1 shows steps of a process for carrying out an embodiment of the invention.

FIG. 2 shows steps of a process for carrying out an embodiment of the invention.

FIG. 3A is a front view of an embodiment of the invention.

FIG. 3B is a partial cutaway side view of the device in FIG. 3A.

### DETAILED DESCRIPTION OF THE INVENTION

For purposes of illustration, and without claiming to address all species potentially present, we indicate here the spontaneous chemical reactions that occur when said HTH granules, resin, and water are combined according to the present invention.

From minerals in water plus carbon dioxide (hardness of source water):

Mg(OH)₂+CO₂→Mg²⁺ (aq)+2 HCO₃⁻(aq) and

Ca(OH)₂+CO₂→Ca²⁺ (aq)+2 HCO₃⁻(aq)

From HTH+water (HTH granule dissolution):

Ca(OCl)₂ (s)→Ca²⁺ (aq)+2 OCl⁻(aq) and

CaCl₂ (s)→Ca²⁺ (aq)+2 Cl⁻(aq) and

NaCl(s)→Na⁺ (aq)+Cl⁻ (aq) and

Ca(OH)₂ (s)→Ca(OH)₂ suspension

From HTH+water+Acid form resin (spontaneous reactions enabling an embodiment of the invention):

Hardness reducing:

Mg²⁺ (aq)+2 HCO₃⁻(aq)+2 R—COOH→(RCOO—)₂ Mg²⁺ (s)+H₂O (1)+CO₂ (g)

Ca²⁺ (aq)+2 HCO₃⁻(aq)+2 R—COOH→(RCOO⁻)₂ Ca²⁺ (s)+H₂O (1)+CO₂ (g)

Neutralizing suspended Ca(OH)₂:

Ca(OH)₂+2 RCOOH→(RCOO⁻)₂ Ca²⁺ (s)+2 H₂O (1)

Ion exchange:

2 RCOOH+Ca²⁺ (aq)+2 OCl⁻ (aq)→(RCOO⁻)₂ Ca²⁺(s)+2 HOCl (aq)

The driving forces for these spontaneous chemical reactions are the solvation energies of the various ions, the strong basicity of the hydroxide ion (pKₐ=14), the relatively weak acidity of the hypochlorite ion (pKₐ=7.46) and the acidity of the ion exchange resin (pKₐ˜4.75 for weak acid cation exchange resins). Thus, when the solution pH is 7.46, 50% of the hypochlorite ions are protonated as a result of the equilibrium balance of chemical forces in the solution. In this instance, H⁺ will transfer from the resin to the OCl⁻ ions because there is 2.71 units of difference, or around a factor of about 500 in favor of the HOCl+Resin-Mⁿ⁺ reaction. Thus, it will be recognized by those skilled in the art that aforementioned reactions are generally spontaneous due to energy considerations and accompanied by relatively rapid kinetics. After mixing and reaction, at least as much as 50%, 80%, 90%, 95% or 97% of the hypochlorite ion is protonated and present as hypochlorous acid. Therefore, the desired hypochlorous acid solutions may be realized spontaneously within a short period of time by combining the components of the present invention.

Said resin and its counterions, above denoted [(RCOO⁻)₂M²⁺ (s)] may be removed from the solution once the said spontaneous chemical reactions are substantially complete, for example, by decantation, filtration, or other process as may cause the liquid and solid present in the resin-salt reaction mixture to separate. The system may optionally contain a filtration device, such as a woven or patterned filter or filter membrane fabricated from common materials such as nylon, polyester, polytetrafluoroethylene, polyethylene, polypropylene, and the like. The resin materials may be stored in the described system encased in such a polymer fabric in order to form a filter bag to facilitate removal of the resin containing metal salt once the reaction providing hypochlorous acid is substantially complete.

In an embodiment, one may create an acid production system by enclosing a load of both the dry hypochlorite salt and the dry resin within the same packet or sachet (or filter bag). Then one may immerse in water said packet or sachet, preferably constructed from polyester mesh fabric. The dry hypochlorite salt dissolves in the water providing a hypochlorite solution, and the acid-form ion exchange resin then undergoes ion-exchange reactions with the solution, providing the hypochlorous acid solution and polymer-bound metal cations. These processes and reactions may be accelerated by shaking, stirring, or other agitation to assist principally in the dissolution of the hypochlorite salt. Finally, optionally, the packet or sachet can be removed from the solution produced, removing all or substantially all of the resin and the cations now bound thereto.

A polyester ‘screen print mesh’ fabric may be used. This is a fabric made from single thread polyester woven into a tight weave with very small pores that is nonetheless allows rapid penetration of water through the pores. The sachet may be formed of the mesh fabric, filled with the dry hypochlorite salt and the dry resin, and the sealed, such as with an impulse sealer. In commerce, the sizes of these pores are standardized and the fabrics are numbered according to the standard US Mesh sizes. The mesh value may be chosen to result in a pore size smaller than the smallest expected bead of the ion exchange resin. For example, some of the resins mentioned above are provided with a particle size range of, for instance 16-50 Mesh. Therefore, choosing a polyester screen print fabric with a higher mesh value (smaller pore size) is preferred in order to facilitate physical sequestration of the ion exchange resin to a small volume of the solution while allowing rapid and free molecular level exchange with the solution, and such sequestration serves to ease the removal of the resin particles from the solution once the desired final conditions of HOCl concentration are reached, simultaneously removing a large fraction of cations contributed by the dry high test hypochlorite. In this manner, the final HOCl solution produced has a much lower level of total dissolved solids (TDS) than can be produced, for instance, by electrolysis of metal chloride solutions.

Referring to FIGS. 2A & 2B, in an embodiment of the invention, acid production system 1 includes sachet 10 (filter bag) and load 20. Sachet 10 is formed of mesh fabric 11 including pores 12. Sachet 10 has seal 14, which closes an opening used to fill sachet 10 with load 20 to preclude load 20 from escaping therefrom. Load 20 includes resin 21 and hypochlorite salt 22.

In an embodiment, the composition, process, and system provide the ability to generate hypochlorous acid on demand at a location where weight transport is at a premium. At typical application dilutions of hypochlorous acid, the overwhelming majority, greater than 99%, 99.5%, or even 99.95% of the solution is water.

As hypochlorous acid is an effective biocide and disinfectant, many even non-potable or stagnant water sources may be envisioned as suitable for use with embodiments of the invention, as long as sufficient hypochlorous acid concentration is achieved to effectively reduce the biohazard to an acceptable level. This is advantageous over other forms of hypochlorite/hypochlorous acid, peroxide, and other biocides that must be transported as solutions.

Additionally, embodiments of the invention may be built at a size suited for the intended use. A small system may be used by one or a few individuals, while a large system could provide hypochlorous acid suitable for many users on either a batch or continuous flow basis. In other embodiments, a container or vessel for carrying out any of the disclosed processes may be provide and used for that process. Such a container or vessel would have at least one opening through which the various dry and wet components of the invention may be introduced and removed.

In embodiments of the invention, the components can be designed to be disposable or recyclable, as resources may allow. The acid-form of the resin, H⁺-Resin, may be regenerated by treating the metal-form of the resin, Mⁿ⁺-Resin with a suitable aqueous acid, such as dilute acetic acid, dilute hydrochloric acid, etc. In this manner, the system of the present invention may alternately be fed by hypochlorite salt solutions, to generate hypochlorous acid, followed by water to remove residual hypochlorous acid, followed by acid to regenerate the resin, followed by water to remove residual acid, and the cycle repeated. The scale on which this exchange may be effected may be very small (g scale) or very large (ton scale, as in a water treatment plant or similar industrial installation).

Resin manufacturers often note that combination of ion exchange resins with oxidizing agents such as nitrates should be avoided due to uncontrollable reaction of the nitric acid thus formed with the benzene rings available on the resin. However, this limitation typically applies to strong acid cation resins, those containing sulfonated polystyrene and similar chemicals, which can undergo nitration reactions. With the weak acid cation resins, there are many fewer benzene rings present (due only to the cross-linking divinylbenzene component of the resin), as they may or may not be present on the crosslinker, but typically not on the polymer backbone. A mild discoloration of the ion exchange resin when contacted with concentrated hypochlorite salt solutions may occur, but strong evolution of heat is avoided. In particular, temperatures were not seen to increase substantially.

A further distinction is that, in the case of a weak acid ion exchange resin, only a weak organic acid, pKa˜5, is available for reaction with the hypochlorite salt and any spectator salts. Therefore, while a strong acid cation resin, a common type of ion exchange resin used in water softening, may be employed, said strong acid resins are less applicable because they may result in pH values substantially lower than the preferred range of pH 4-7.

Mixtures of resins of various types are also operable. For instance, a mixture of a strong acid cation H-form resin and a weak acid cation salt form, e.g., Na+-form resin practically provide a buffered weak form cation resin once contacted with water. Thus, various mixtures of weak- and strong-form resins such as these are contemplated in embodiment of the invention. One could formulate a mixture of such resins which effectively performs similar functions, but has advantages of cost, availability, etc. depending on prevailing commercial conditions or other consideration. In another embodiment, a dry acid (such as tartaric, citric) is mixed with the other dry components (a Na+ resin and hypochlorite salt). In this embodiment, the dry acid, the resin, and the hypochlorite salt would be used to combine in an aqueous solution to form hypochlorous acid and a mixture of metal-ion form resin and metal-ion salt of the acid, which might itself be barely soluble or even insoluble in the final mixture. While not a preferred embodiment of the invention, such mixtures are operable within the context and spirit of the instant invention.

As noted above, the control of the pH of the resulting solution is due to the masses of hypochlorite salt and weak acid cation exchange resin mixed in the process or system. Typically the conditions are selected so that there is an excess of ion-exchange resin H⁺ sites, from 50% to 5000%, and preferably from 400% to 900% or from 600% to 900%. In this manner, the pH of the water used, from natural, commercial, or utility sources, does not play a strong role in the pH of the final composition, rather by the concentration of hypochlorite salt and H⁺-resin. If excess hypochlorite salt were present, the pH of the resulting mixture would likely exceed 7.5, where over half the hypochlorite ions would be present in ionized form. Therefore it is important to use a suitable excess of H⁺-form resin. Providing excess resin also assists in ensuring quick reaction times once mixed with water, and by diluting the fraction of hypochlorite in the dry mixture, thus rendering that mixture safer to handle. When employing the preferred weak acid cation resin in H-form, even excess resin will not cause over-acidification of the solution; only salts of weak acids will be protonated under the conditions of use of the compositions, processes, and systems. The typical pH of a resulting solution is preferably between about 2.25 and 7, or about 3.5 and 7.4, or about 3.5 and 8.0, even more preferably between 3.5 and 6.5, and even more preferably between 5 and 6. In particular embodiments, the process can include combining the salt and the resin in such portions that the available protons are sufficient to protonate at least 50%, at least 90%, or at least 97% of the hypochlorite ions.

In sum, this invention: 1) provides for the dry transportation of an equivalent of hypochlorous acid; 2) substantially lessens concerns regarding the stability of hypochlorous acid in solution by providing a means of preparation anywhere water is available; 3) controls the final pH of the solution to a regime where the majority of hypochlorite species are present as hypochlorous acid; 4) with suitable compositions, dramatically lessens the soluble compounds such as sodium chloride, calcium chloride, hydrochloric acid, molecular chlorine (Cl₂), salts of isocyanuric acid, buffering agents, and other undesirable byproducts produced by alternative compositions, processes, and systems.

### EXAMPLES

We have found that solutions of hypochlorous acid in a suitable range of pH may be generated by treatment of dilute alkali and alkaline earth hypochlorites with such H⁺-form ion exchange resins. The dilute solutions of HOCl thus produced, in the range from 200-2000 ppm free available chlorine (FAC) are largely colorless and contain much lower concentrations of other ionic species, 1-2 orders of magnitude less than the electrolytic solutions of hypochlorous acid formed from sodium chloride solutions. The counterions, typically calcium, of the hypochlorite are removed from the solution by the ion exchange mechanism. By removing the ion exchange resin, typically in the form of a gel or small beads, a more pure and useful solution results. The following examples are illustrative.

### Example 1

1.0 g of HTH Calcium hypochlorite granules, (min FAC 70%), was dissolved in 250 cc of water from the local municipal supply by shaking for 5 minutes. A pale milky white mixture resulted, revealing the presence of Ca(OH)2 in suspension. The pH measured by electrode was ˜12 and the ORP was ˜500 mV. 3 grams of H+-form weak acid ion exchange resin Amberlite CG50 was added at once, and the mixture shaken for two minutes. The ion exchange resin was allowed to settle, and the solution decanted. The principal solute was hypochlorous acid. The pH of the clear resulting solution was 6.0 and the ORP 1025 mV. At pH 6.0 approximately 97% of the hypochlorite ion is protonated and present as hypochlorous acid. The FAC was tested with a test strip and registered over 2,000 ppm. The solution was diluted to 1 gallon with additional municipal water, and tested again. The pH was 6.1 and the FAC was over 200 ppm.

### Example 2

1.0 g of HTH Calcium hypochlorite granules, (min FAC 70%), was admixed with 3 g of H+-form weak acid ion exchange resin Amberlite CG50 in a closed Nalgene 500 cc bottle for 1 week. No gas evolution, color change, or odor increase was noted. 250 cc of municipal supply water was added and the mixture shaken for 5 minutes. The ion exchange resin was allowed to settle. The solid comprised excess H⁺-form resin as well as a lesser amount of Mⁿ⁺ form resin. The pH of the clear resulting solution was 6.2 and the ORP 1001 mV. The FAC was tested with a test strip and registered over 2,000 ppm. The solution was diluted to 1 gallon with additional municipal water, and tested again. The pH was 6.1 and the FAC was over 200 ppm.

### Example 3

1.0 g of HTH Calcium hypochlorite granules, (min FAC 70%), was dissolved in 250 cc of water from the local municipal supply by shaking for 5 minutes. A pale milky white mixture resulted, revealing the presence of lime (Ca(OH)₂) in suspension. The pH measured by electrode was ˜12 and the ORP was ˜500 mV. 10 grams of H+-form weak acid ion exchange resin Amberlite MAC-3H (supplied as 50% resin/50% water by weight) was added at once, and the mixture shaken for two minutes. The ion exchange resin was allowed to settle, and the solution decanted. The pH of the clear resulting solution was 6.0 and the ORP 1006 mV. At pH 6.0 approximately 97% of the hypochlorite ion is protonated and present as hypochlorous acid. The FAC was tested with a test strip and registered over 2,000 ppm. The solution was diluted to 1 gallon with additional municipal water, and tested again. The pH was 6.1 and the FAC was over 200 ppm.

### Example 4

109.44 g of Amberlite MAC-3H ion exchange resin was dried in an oven under air at 107° C. for 12 hours. The resulting dry solid weighed 55.80 g, suggesting a water content of 49% in the as-received resin. 1.0 g of HTH Calcium hypochlorite granules, (min FAC 70%), was dissolved in 250 cc of water from the local municipal supply by shaking for 5 minutes. A pale milky white mixture resulted, revealing the presence of lime (Ca(OH)₂) in suspension. The pH measured by electrode was ˜12 and the ORP was ˜500 mV. 5 grams of the dried H⁺-form weak acid ion exchange resin Amberlite MAC-3H was added at once, and the mixture shaken for 15 minutes. The ion exchange resin was allowed to settle, and the solution decanted. The pH of the clear resulting solution was 5.9 and the ORP 1020 mV. The FAC was tested with a test strip and registered over 2,000 ppm. The solution was diluted to 1 gallon with additional municipal water, and tested again. The pH was 6.1 and the FAC was over 200 ppm.

### Example 5

50.0 g of the dried resin of example 4 was admixed with 10 grams of HTH Calcium hypochlorite granules, (min FAC 70%), and this mixture allowed to stand for several days at room temperature in a closed Nalgene bottle. No evolution of gas, discoloration, or increase in odor was noted.

### Example 6

10 g of a sulfonic acid ion exchange resin were treated with 50 cc of 3N HCl, filtered, and thoroughly rinsed with water until the rinse pH was neutral. 1.0 g of HTH Calcium hypochlorite granules, (min FAC 70%), was dissolved in 250 cc of water from the local municipal supply by shaking for 5 minutes. A pale milky white mixture resulted, revealing the presence of lime (Ca(OH)₂)in suspension. The pH measured by electrode was ˜12 and the ORP was ˜500 mV. The strong acid cation exchange resin was added at once and the mixture swirled for a few seconds. The pH was 4 and the ORP was 1075 mV. This mixture was decanted from the resin beads and diluted to 1 gallon with municipal water. The pH was 6.4 and the ORP was 975 mV.

### Example 7

With reference to FIG. 2, in step 100, a sachet was constructed from 180 mesh polyester screen print fabric by sealing all but one side with an impulse sealer, leaving an opening on one side. Next in step 110, 10 g of the dried MAC3-H resin from example 4, was introduced to the sachet, followed by step 120 which introduced 1 g of HTH Calcium hypochlorite granules, (min FAC 70%). The resin and granules were sealed inside the sachet with the impulse sealer in step 130. Step 140 was skipped. In step 150, the sachet was introduced to 1 pint of distilled water and allowed to stand for 15 minutes in step 160, thus permitting water to enter the sachet through pores in the material and mix with the HTH and resin. At step 170, the process is complete. The solution was diluted to 1 gallon and tested for FAC. The level of FAC was approximately 200 ppm as determined by a commercial FAC test strip.

### Example 8

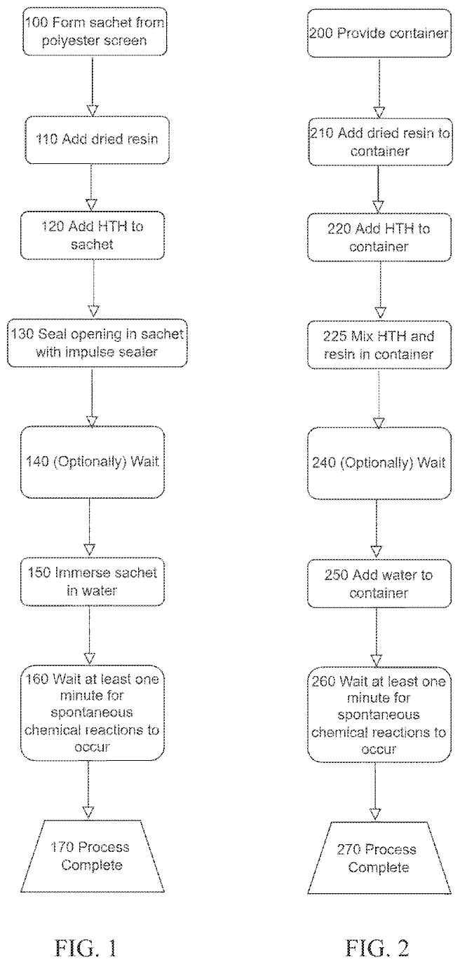

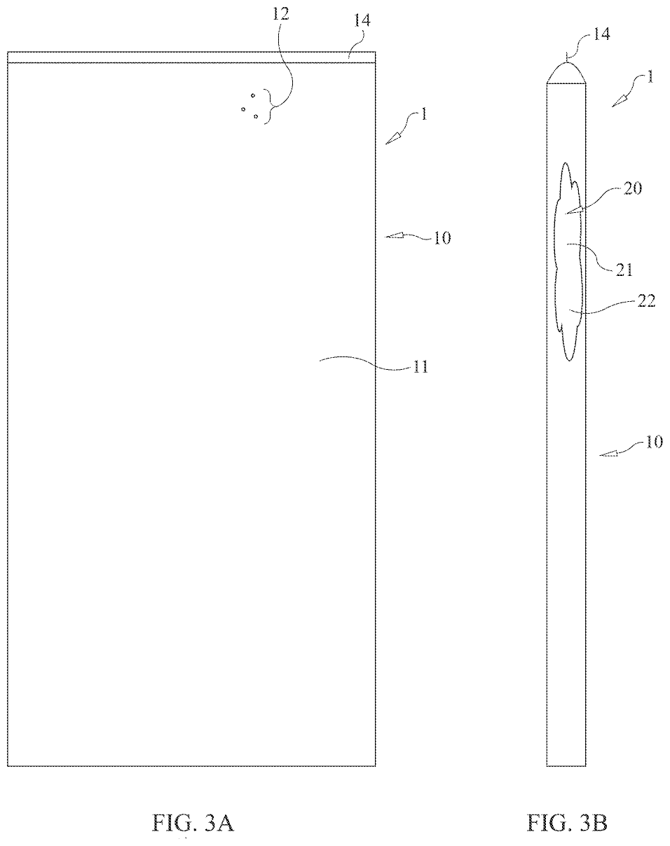

Again with reference to FIG. 1 and example 7, a sachet similar to that of example 7 was constructed by following steps 100, 110, 120, and 130. The sachet was then allowed to age under room conditions for several weeks (step 140). The immersion process into one gallon of water, step 150, was then conducted, followed by step 160, where spontaneous chemical reactions were allowed to proceed. At step 170, the process is complete. The FAC was measured at 200 ppm with a commercial FAC test strip.

### Example 9

With reference to FIG. 2, in step 200, a container is provided for the resin and salts. Next in step 210, dried resin is introduced to the container, followed by step 220 in which HTH is added to the container. In step 225, the HTH and dried resin are mixed in the container. In step 240 an optional waiting period is observed. In step 250, water is introduced into the container, permitting water to mix with the resin and HTH. In step 260, a waiting period of at least 1 minute is observed. At step 270 the process is complete.

The foregoing examples show in many respects different aspects of the instant invention which are itemized in the claims below. They show a ready, flexible, scalable, and economic method of generating a consistent and predictable solution of hypochlorous acid from solid precursors which additionally features much lower concentrations of spectator ions than competing methods. This solution of hypochlorous acid may find uses in human and animal medicine, general cleaning, flower preservation, antimicrobial treatments and many other uses where the advantages of hypochlorous acid are known.

1. A mixture of
at least one hypochlorite salt containing hypochlorite ions; and
at least one cation exchange resin in predominantly protonated (H+) form containing available protons;
the salt and the resin in such proportion that the number of available protons contained in the resin is greater than 50% of the number of hypochlorite ions.

2. The mixture of claim 1, wherein said cation exchange resin comprises a material selected from the group consisting of crosslinked polymers of acrylic acid, crosslinked polymers of methacrylic acid, and sulfonated crosslinked polystyrene.

3. The mixture of claim 1, the salt and the resin in such proportion that the number of available protons contained in the resin is greater than 90% of the number of hypochlorite ions.

4. The mixture of claim 1, the salt and the resin in such proportion that the number of available protons contained in the resin is greater than 97% of the number of hypochlorite ions.

5. The mixture of claim 1, said resin dried to remove substantially all water therefrom.

6. The mixture of claim 1,
the salt comprising granular commercial grade hypochlorite;
said hypochlorite containing at least 65% by mass of free available chlorine; and
the mixture comprising resin and salt in a mass ratio of at least about 5:1.

7. The mixture of claim 6, the mixture comprising resin and salt in a mass ratio of at least about 8:1.

8. The mixture of claim 1,
further comprising water;
the salt and resin in the water forming an aqueous mixture containing hypochlorous acid and at least one substantially insoluble cation exchange resin;
said at least one substantially insoluble cation exchange resin being present in mixed cation form.

9. The mixture of claim 8, said mixed cation form comprising both protons and metal ions, the metal ions being of Group I or Group II.

10. The mixture of claim 8,
said mixture having a pH of more than 3.5 and less than 7.4; and
said mixture containing from 10 to 25,000 parts per million of free available chlorine.

11. The mixture of claim 10,
said mixture having a pH of more than 5 and less than 6; and
said mixture containing from 200 to 2000 parts per million of free available chlorine.

12. The mixture of claim 8,
further comprising at least one solute;
further comprising a sealed filter bag;
said filter bag enclosing the salt and the resin within the filter bag;
said filter bag retaining a substantial amount of the resin within said aqueous mixture; and
said filter bag allowing the water, the aqueous solution, and the at least one solute to permeate therethrough.

13. The mixture of claim 1, the salt further comprising at least one inorganic salt selected from the group consisting of an alkali chloride, an alkali hydroxide, an alkaline earth chloride, and alkaline earth hydroxide.

14. The mixture of claim 1,
said mixture also containing acidic components admixed therein to form an admixture;
wherein said admixture is substantially stable over a period of at least about a year.

15. The mixture of claim 1, said hypochlorite salt comprising at least one hypochlorite selected from the group consisting of an alkali hypochlorite, a basic alkali hypochlorite, an alkaline earth hypochlorite, a basic alkaline earth hypochlorite, and a mixture of any of these above hypochlorites.

16. A process for forming hypochlorous acid, comprising:
combining a hypochlorite salt containing hypochlorite ions, at least one cation exchange resin in predominantly protonated (H+) form containing available protons, and water; and
said combining step comprising combining said salt and said resin in such portions that the available protons are sufficient to protonate at least 50% of the hypochlorite ions; and
allowing said mixture to spontaneously react for a period of 1 minute or longer.

17. The process of claim 16, further providing a container or vessel with at least one opening through which the various said components may be introduced and/or removed, and allowing said spontaneous reaction to happen within said container or vessel.

18. The process of claim 16, further comprising:
introducing the hypochlorite salt and the at least one cation exchange resin into a container having at least one opening; and
after the allowing step, removing protonated hypochlorite ions from said container through the at least one opening.

19. The process of claim 16, said combining step comprising combining said salt and said resin in such portions that the available protons are sufficient to protonate at least 90% of the hypochlorite ions.

20. The process of claim 16, said combining step comprising combining said salt and said resin in such portions that the available protons are sufficient to protonate at least 97% of the hypochlorite ions.

22. The process of claim 16, further comprising removing at least a portion of the insoluble solids from the mixture.

23. The process of claim 16, further comprising, prior to the combining step, drying said resin to remove substantially all water therefrom.

24. The process of claim 16, wherein, after the allowing step, the mixture has a pH of more than 3.5 and less than 7.4 and contains from 10 to 25,000 parts per million of free available chlorine.

25. The process of claim 16, further comprising:
before the combining step, enclosing the hypochlorite salt and the at least one cation exchange resin in a filter bag; and
allowing the water to permeate through the filter bag to mix with the hypochlorite salt and the at least one cation exchange resin.

26. A system to produce hypochlorous acid, comprising:
a water permeable filter bag; and
a load, the load comprising
at least one hypochlorite salt containing hypochlorite ions; and
at least one cation exchange resin in predominantly protonated (H+) form containing available protons;
the salt and the resin in such proportion that the number of available protons contained in the resin is greater than 50% of the number of hypochlorite ions.

27. The system of claim 26,
the filter bag comprising a synthetic polymer; and
the filter bag having an effective US mesh size of greater than or equal to 50.

28. The system of claim 26, further comprising a protective package;
said protective package holding the filter bag within.

29. The system of claim 28, further comprising a dessicant within said protective package.
